(19) United States
(12) Patent Application Publication
(10) Pub. No.: US 2003/0207006 A1
(43) Pub. Date: Nov. 6, 2003

(54) Method and system for preparing multiple variety pouched products

(75) Inventors: Don Jurgensen, Easton, PA (US); Bruce Keen, Chattanooga, TN (US); Art Paradissis, Powell, OH (US); Ronald L. Stanke, Placida, FL (US); Gary Skene, Meadowvale (CA); Thomas M. Collins, Nazareth, PA (US); Jeannette Dido, Hoboken, NJ (US)

Correspondence Address: FULBRIGHT & JAWORSKI, LLP, 1301 MCKINNEY, SUITE 5100, HOUSTON, TX, 77010-3095, US

(73) Assignee: Mars Incorporated, McLean, VA

(21) Appl. No.: 10/138,242

(22) Filed: May 2, 2002

(51) Int. Cl. A23B 4/00

(52) U.S. Cl. 426/407

(57) ABSTRACT

The present invention is directed to a system and method for producing multi-packs of pouched pet food containing multiple varieties of a food product or different foods in a continuous production process. The method includes the steps of providing a plurality of meat preparation modules in which each module contains a different variety of a food product or different kinds of food products. A selected meat mixture from a selected meat preparation module is process through a meat forming module. A continuous strip of flexible pouches is provided for filling. The continuous strip of flexible pouches is filled with the selected meat mixture and then the pouches are sealed. The filled flexible pouches are accumulated in a work box. Different varieties of a food product or different kinds of food products are accumulated in a plurality of work boxes. Pouches are selected from the plurality of work boxes in order to form individual multi-packs of pouches wherein each multi-pack includes a variety of a food product or different kinds of food products.

### TECHNICAL FIELD

The present invention relates to a method and system capable of producing pouches of food products, and more particularly to a method and system capable of producing multiple varieties of pouched food products in a continuous production process.

### BACKGROUND OF THE INVENTION

The food industry typically is geared for the mass production of various different types of food products intended for consumption by humans and animals. A mass production assembly line often requires physically large pieces of equipment to handle the volume. Typically, the manufacturing process involves many steps, all of which must be performed at different stations. For example, a typical process for producing a food product (e.g., animal food) may include mixing the ingredients, emulsifying the mixture, shaping or extruding the emulsion into “ropes,” cooking the ropes in a steam tunnel, cutting the cooked product, and storing the cooked product in accumulators until needed for later processing. The process further may include mixing the cooked product with other ingredients (e.g., a gravy), dispensing the mixed product into pouches, sealing the pouches, sterilizing the pouches, and commercial packaging of the final product. It can be seen from this example that numerous stations and large pieces of equipment are needed, all of which may require a large manufacturing facility. Thus, a mass production assembly line often is capital intensive.

To attain the most efficient use of production equipment, a particular assembly line often may be used to manufacture different variations of a food product. For example, the same assembly line might be used to produce a food product made of either chicken or beef. To prevent contamination, the assembly line must be broken down and thoroughly cleaned and sterilized after producing the first variety before the line can be used to produce the second variety of the food product. Stopping and cleaning the assembly line is costly, both in terms of labor and time. An additional cost is incurred because of the food material remaining in the assembly line at the time of shutdown, known as work product in process. This loss in work product is a direct cost in lost tons of product and it also represents an additional cost for the effective treatment of the waste water from the cleaning of the assembly line.

Such cost concerns dictate that large runs of a particular variety of a food product should be completed before stopping and preparing the assembly line for another variety of the food product. However, large runs of a food product mean that mass quantities of the product must be stored until needed. Oftentimes, spoilage and waste may result from inventorying the food product, thus further affecting the cost associated with a mass production facility.

For some food products, it may be desirable to produce relatively small batches at a given time to minimize spoilage, waste and inventory costs. However, it may be cost-prohibitive to use a mass production assembly line to manufacture low volumes of the product due to the expenses associated with stopping and preparing the line for production of a new product. Thus, it would be desirable to provide an assembly line that was cost effective for small batch production of a particular food product or variety of a food product. Using smaller equipment and reducing the number of stations through which the food product must pass could realize such cost effectiveness. For example, it would be advantageous to provide a station at which multiple processing steps could occur. In the case of an extruded or shaped food product, it would be desirable if the food product easily could be shaped and cooked in the same chamber.

In a conventional shaping chamber, an edible emulsion is fed or pumped into a nozzle block having a plurality of ports. The continuous feeding of the emulsion into the nozzle block forces the emulsion through the block and out the ports, thus shaping the emulsion into ropes that are fed onto a large belt in the assembly line. The belt conveys the resulting ropes through a long steam tunnel in which they are cooked until reaching a temperature greater than 85 C. It would be desirable if the shaping and cooking of the emulsion could occur in a single chamber, thus eliminating the need for a lengthy conveyor belt and steam tunnel.

It is desirable in the processing of pet food products or human edible food products, to be able to produce a plurality of multi-packs of individual packages of products, as well as small volumes of specialty products, as compared to the volume of production found in conventional large-scale continuous production processing lines. Currently, the conventional method for providing multi-packs of individual packages of different products is to complete an entire run for each product and then inventory the different packages of products for final assembly and packaging into individual units of multi-packs. Multiple runs lead to large inventories of the individual products. Moreover, this method also leads to delays in further processing and final packaging because a run for each individual variety or product first must be completed. In the current continuous production processes, all of the necessary processes from the introduction of materials to the packaging of the final product, are performed in succession once production starts; hence, once the operation of the continuous production process starts, it is difficult if not impossible to cease the processing at any point in order to effect a change over to a different product or a different variety of product without causing a remarkable decrease in production efficiency. Accordingly, there is a strong demand for the development of a new type of production processing system capable of solving the problems found in conventional continuous food production processing lines for the production of different kinds of products and/or small batches of products in the field concerned.

It is an object of the present invention to provide a high production process capable of simultaneously or successively producing food products of different kinds.

It is still another object of the present invention to provide a process capable of efficiently producing food products in small batches.

It is still another object of the present invention to provide a process capable of producing different kinds of products easily in one production line.

### BRIEF SUMMARY OF THE INVENTION

The present invention is directed to a system and method for producing multi-packs of pouched food containing different varieties of a food product or different kinds of food products in a continuous production process. While the description is principally directed to pet food products, the method and system can be equally useful for the production of human edible food products. The method includes the steps of providing a plurality of meat preparation modules in which each module contains a different variety of a food product or different kinds of food product. A selected meat mixture from at least one meat preparation module is process through a meat forming module.

Flexible pouches are provided for filling with the selected meat mixture and thereafter the pouches are sealed. The filled flexible pouches are accumulated in a work box. Different varieties of a product or different kinds of food products are accumulated in a plurality of work boxes. Pouches are selected from the plurality of work boxes in order to form multi-packs of pouches wherein each multi-pack includes a variety of a food product or different food products.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a schematic block diagram of the food processing system for the food product of the subject invention;

FIG. 2 is a schematic perspective view of the form, fill and seal processing apparatus and the accumulation and packaging apparatus of the subject invention; and

FIG. 3 is a schematic perspective view of an alternate system of the subject invention.

### DETAILED DESCRIPTION OF THE INVENTION

The present invention is directed to a method and system for producing multi-packs of a pouched food product containing different varieties of a food product or different food products in a continuous production process. The inventive method and system is also capable of producing customized food products and small volumes of food products in a continuous production process. While the description is principally directed to pet food products, the method and system can be equally useful for the production of human edible food products.

The present invention provides for quick changeovers in a continuous production process allowing for the production of multi-packs of pouched food products containing different varieties of a food product or different food products. The method and system of the subject invention allows for quick changeovers in the food processing line, particularly for quick changeovers in the meat preparation section. The apparatus for doing this could include using short pipe runs, self-emptying mixer designs, common meat mixes where possible and adding colors, flavors, etc as late in the meat preparation process as possible. This could include the addition of differentiating meats and/or colors and/or flavors into a mixing pump immediately prior to the forming portion of the food processing line.

The apparatus could also include mixing and forming systems having built-in flushing mechanisms to rapidly clean out these pieces of processing equipment in order to prepare the equipment for the next variety of a product or a different product while running out the remainder of the previous variety or product at the pouch filling portion of the process.

The present invention also allows for quick changeovers in the pouch filling portion of the process. The apparatus for doing this could include the use of two sets of filling nozzles in the filling module such that when one set is not in use, it would have a valve that redirects the flow to a drain or other point. This nozzle set could then be flushed and charged with the next variety or product while the other set runs a different variety or product. Alternatively, several pipes could feed into each nozzle in which there would be a pipe for each variety or different product, with electronic controlled valves controlling the flow of the pipe being run. In another embodiment, two pipes could feed into one filling nozzle in which one nozzle would be filling the pouches while the other nozzle would be flushing and charging with another variety or different product. Since the subject method and system allows for a small amount of buffer time between the meat preparation process and the filling process, it is not critical that a filling and sealing process be running at the same time as the meat preparation process. Thus, a processing time allowance could be built into the subject method and system for flushing, etc, while allowing for the filling and sealing process to run continuously.

The inventive method and system can be used to produce dry, moist and semi-moist pet food products, pet snacks and pet treats, and human edible food products. The human food products can include meat and vegetable chunks in a sauce, meat chunks or vegetable pieces in a sauce, rice or pasta products with a sauce or any combination thereof. However, the process described below is generally directed to a semi-moist chunk type pet food packaged with a gravy in a sealed pouch container. The processes for forming dry and moist pet food products, pet snacks and treats, and human edible pouched food products are known to those skilled in the art of manufacturing edible pet products.

In the semi-moist pet food product, the chunks are generally pieces of formed meat or meat by-products, which is the primary content of the chunk. Also present in the chunk are usually grains and fibrous materials as well as vitamins and minerals. These materials are generally present as the minor portion of the chunk. The gravy portion usually has a fluid characteristic and supplies aroma, palatability, and some additional nutritional properties to the food product such as additional vitamins, minerals and the like.

Included within the term “meat” are those meat-derived ingredients defined as “meat” and “meat-by-products” by the current Definitions of Feed Ingredients published by the Association of American Feed Control Officials, Incorporated. Preferred meat sources for the meat mixture components include beef, lamb, veal, chicken and the like and combinations thereof. Meat and meat by-products comprise about 60 to about 85% of the meat chunk component of the meat chunk and gravy food product. The remainder of the meat chunk generally comprises grain, fibrous materials, vitamins, and the like. Wheat flour, dry blood plasma and dried egg are frequently used as binding agents for the product prepared from the ingredients from which the meat chunks are manufactured. Vitamins and minerals can also be added. In addition to these ingredients, various minor ingredients such as nutritional supplements, salts, coloring agents, and the like, are also included in the meat chunk formation to provide nutritional balance and palatability.

The gravy component typically comprises water and thickening agents. These thickeners are chemically modified starch(es), gum(s) and mixtures thereof. Examples of chemically modified starches include starches from corn, wheat, rice, potato, tapioca and the like which are modified by any or a mixture of acylation such as acetylation, cross-linking from groups such as phosphate, hydroxyalkyl such as hydroxypropyl. Examples of gums include xanthan, guar, locust bean, carboxymethylcellulose, and the like. Other ingredients, which may be included in the gravy component, are soluble carbohydrates such as maltodextrin, sucrose and corn syrup, as well as also salts, colors, flavors and emulsifiers such as lecithin. The gravy component can also include a cooking step in order to enhance the flavoring in the gravy component, particularly if a non-thermal sterilization process is used. This thermal treatment can also be used to provide the same degree of microbiological kill as is present with non-thermal final sterilization.

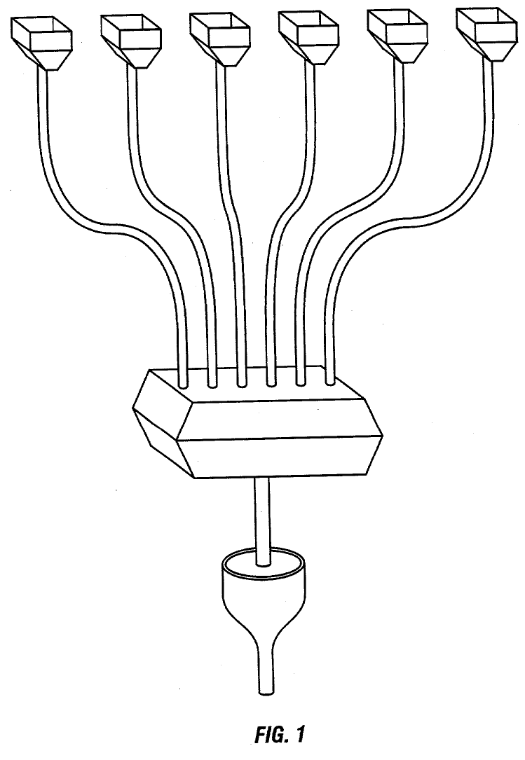

The method and system of the present invention can include a pet food production line 10 that includes at least one meat preparation module 12, and a meat forming and cooking module 14, a pouch forming module 16, a filling and sealing module 18, an accumulating module 20, and a packaging module 21 (FIGS. 1-3). The meat preparation module 12 typically includes at least the steps of grinding the meat to a relatively fine grind by passing broken frozen blocks of the meat through a grinder where the meat is sized to particles between ⅛ and ½ inch and then feeding the comminuted, sized particles into a meat emulsion blender where the meat particles are blended with a grain fiber, when employed, binders such as plasma, wheat flour and dry egg, nutrients, minerals and salts to form a meat mixture emulsion.

A number of meat preparation modules 12, preferably at least six, are present in which each module 12 can contain ingredients for a different variety of a meat chunk such as a beef chunk, chicken chunk, veal chunk, lamb chunk, a veal and chicken chunk or a beef and lamb chunk or any other meat combination. Alternatively, different kinds of pet food products could be in each of the modules 12, such as a dry pet food, wet pet food, semi-moist pet food, pet snacks and pet treats. Additionally, customized meat mixtures can be prepared in any of the meat preparation modules 12. The type and configuration of the processing utilized in the meat preparation modules 12 is such that multiple small batches or product volumes can be efficiently processed simultaneously. Thus, simultaneous processing of the multiple meat preparation modules 12 will allow for the efficient preparation of different varieties of a pet food product and different pet food products.

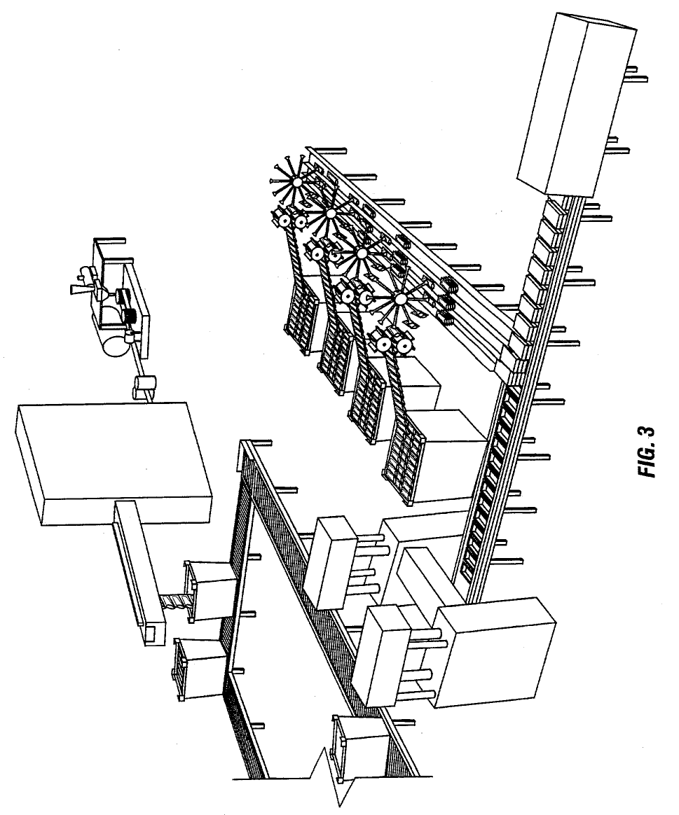

Preferably, each of the meat preparation modules 12 is connected to a single meat forming module 14 through transfer pipes 22 (FIGS. 1, 3) as is known to one skilled in the art. The flow of the prepared meat mixture emulsion from any one of the meat preparation modules 12 is electronically controlled so that the flow of the meat mixture emulsion from any one meat preparation module 12 can be selected and volume controlled.

The meat forming and cooking module 14 includes at least the steps of transferring the emulsion through an extruder from which it is uniformly deposited onto a moving cooking belt of the desired dimensions. The emulsion can be deposited in a sheet or an elongated rope shape, having a thickness for example of about ¼ to 1 inch. This process is known to one skilled in the art of pet food manufacturing. The ropes are cooked in a tube or tunnel and the cooking of the ropes can be accomplished by a number of heating sources such as steam, ultrasound or microwave. The ropes are cut to the desired chunk dimensions and the cut meat components are transported on conveyors to a holding container to accumulate until needed at a filling station portion 34 that is part of the filling and sealing module 18. If the pet food product includes a gravy, it is prepared separately from the meat pieces and pumped to a hold tank 13 near the filling station portion 34. If a dry pet food is being produced, the cut meat components are transported through a drying process.

Alternatively, the meat forming and cooking module 14 can include the process described in U.S. patent application Ser. No. ______, titled “Method and System for Moving an Edible Substance Through a Heated Chamber”, concurrently filed and incorporated in its entirely herein. This process includes a fixture having at least one shaped chamber that extends between a first open end and a second open end. A flowable substrate is introduced into the fixture having an elongate shaping chamber extending between first and second open ends. The flowable substrate is heated in the chamber to produce a cooked, shaped product. A pushing force is applied to the cooked product which is directed toward the second open end. The pushing force expels the cooked product from the chamber through the second open end. In one embodiment, the pushing force is provided by a pushing device insertable at the first open end. Vibrational energy also may be applied to the chamber to facilitate expelling the cooked product therefrom. The chamber may have any of a variety of shapes, such as tubular with a circular cross section or tubular with a cross section resembling a star, a dog bone, etc. If desired, the walls of the chamber may be coated with a non-stick coating to facilitate movement of the emulsion through the chamber.

A filling device is in communication with the chamber to introduce the emulsion into the chamber. For example, the filling device may be a hopper in communication with an inlet of the chamber. Sufficient emulsion is introduced into the chamber via an inlet such that the chamber can impart a shape to the emulsion. The filling device can be configured to introduce the emulsion into the chamber in either a continuous or non-continuous manner.

A thermal energy source is also in communication with the chamber. The thermal energy source may be any conventional heating unit that is configured to heat the one or more chambers to an appropriate temperature to adequately cook the emulsion therein. For example, in one embodiment, the heat source is capable of heating the chamber such that the temperature of the substrate reaches at least 85° C. The amount of heat necessary and the length of time needed to cook the emulsion will depend on the type of emulsion, the dimensions of the chamber, the configuration of the chamber, etc., as would be readily understood by one of ordinary skill in the art. After the emulsion reaches an adequate temperature, it is removed from the chamber through the second open end.

The pushing assembly may include one or more piston or plunger-like members, each of which is insertable within a respective chamber. In one embodiment, the pushing assembly may include a drive unit that controls the movement of the piston/plunger members. The drive unit, in turn, may be in communication with a monitoring device that provides control signals to cause the drive unit to appropriately activate or deactivate the piston/plunger members. For example, the monitoring device may monitor filling of the chamber and/or the heating of the substrate within the chamber. When the substrate has reached an adequate temperature or after a sufficient time has passed to ensure that the substrate is properly cooked, then the monitoring device may generate a control signal that activates the pushing device such that the pistons/plungers are inserted into the one or more chambers.

The pushing device is configured to generate a pushing force directed from the first open end toward the second open end. In one embodiment, the pushing force is sufficient to separate the cooked substrate from the chamber walls and to expel the cooked substrate from the chamber. Once removal of the cooked substrate is ensured, then the pushing device may retract the piston/plunger members such that additional substrate may be introduced into the recently vacated chamber.

In an alternative embodiment, a mechanical vibrational energy source also is in communication with the fixture. The vibrational energy source may be configured to generate sufficient vibrational energy to at least partially loosen or separate the outer surface of the cooked substrate from the surfaces of the chamber walls. If the bond is broken in this manner, then the force generated by the pushing device upon the cooked substrate can be reduced. This feature may be desirable if the separation force that otherwise would have to be generated by the pushing device may damage the shape of the cooked substrate. In one embodiment, the mechanical vibrational energy source may be a conventional ultrasonic energy source.

Alternatively, the pushing device may be omitted if the vibrational energy source is configured to vibrate the walls of the one or more shaping chambers sufficiently to prevent the flowable substrate from adhering to the wall surfaces and/or to loosen any adhered portions of the flowable substrate. In this embodiment, the pushing force that expels the cooked, shaped product from the outlet comes from the flowable substrate entering the chamber in either a continuous or discontinuous manner. Such an embodiment offers the additional advantage of enabling a continuous filling, shaping, and cooking process, because filling of the chamber need not be halted to allow for insertion of the pushing device. Further, in this embodiment, the flowable substrate may enter the one or more shaping chambers either via the inlet or via a feed tube in communication with the first open end.

In yet another embodiment, the flowable substrate can be fed into the chamber in a continuous manner for a period of time and then paused to allow for insertion of the pushing device. Such a configuration is useful if the pushing force from the entering substrate is sufficient to move the substrate through the chamber, but a certain amount of residue remains adhered to the surface of the chamber wall. Periodic insertion of the pushing device can thus clean the chamber wall surfaces to prevent burning and/or buildup of the residual material.

Either while or after the cooked emulsion has exited the chamber at the second open end, a cutting device may cut the cooked, shaped emulsion into smaller pieces or chunks. For example, the cutting device may include a rotating cutting blade that slices the emulsion as it exits the chamber. The cut pieces then may be conveyed to the next station in the assembly line or placed in an accumulator for later use.

Alternatively, the meat forming and cooking module 14 can include the process described in U.S. patent application Ser. No. ______, titled “Method and System for Continuous Forming of a Cooked Food Product Using Ultrasonic Energy”, concurrently filed and incorporated in its entirely herein. In this process, the flowable emulsion is both shaped and cooked in a single chamber. The passage of the emulsion through the chamber must be timed to ensure that it is adequately cooked while therein. The amount of time needed to cook the substrate will depend on a variety of factors, such as the dimensions of the chamber, the composition of the flowable emulsion, and the type of energy source used to cook the substrate. In one embodiment, the emulsion is passed in a continuous manner through the chamber and the energy source applies the cooking energy in a continuous manner. In other embodiments, the process may be configured such that the emulsion fills a chamber, and then remains at rest until it is thoroughly cooked. In such an embodiment, the energy source may be configured to apply the cooking energy in a discontinuous manner. For example, the energy source may be activated only while the substrate is at rest in the chamber.

In accordance with a further aspect, the process comprises shaping the flowable substrate by feeding the substrate through a shaping fixture comprising a plurality of chambers. A sufficient volume of the flowable substrate is introduced into the cavity such that the substrate contacts substantially all of the shaped surface. The shaped surface is vibrated to impart cooking energy to the volume of the substrate introduced into the cavity. The flow rate of the substrate through the cavity is controlled such that sufficient cooking energy is imparted to thoroughly cook the entire volume of the flowable substrate. Each of the chambers is defined by a wall having a shaped surface. Each of the shaped surfaces has a unique shape. For example, each chamber may be generally tubular with a circular cross section, a star-shaped cross section, a crescent-shaped cross section, a dog-bone-shaped cross section, etc. While the substrate is fed through the chambers, the shaped surfaces are vibrated to impart sufficient energy to cook the flowable substrate. When the flowable substrate exits the chambers, it is cut to form a mixture of uniquely shaped chunks.

The flowable substrate is both shaped and cooked in the fixture. In one embodiment, the flow rate of the substrate through the fixture is controlled to ensure that the substrate is cooked as desired while in the shaping chamber. The amount of time needed to cook the substrate will depend on a variety of factors, such as the dimensions of the chamber, the composition of the flowable substrate, the type of energy source used to cook the substrate, and the desired cooking result. For example, thorough cooking of the entire volume of a protein-based substrate has been attained in approximately 10 seconds in a continuous feed process using a titanium shaping/cooking fixture having a tubular shaping chamber approximately one-half inch in diameter and 4 inches in length. In this configuration, the cooking energy was provided by a 20 KHz ultrasonic energy source having a 2000-3000W output in communication with the fixture.

In addition to providing energy to cook the substrate, the vibration of the surface of the wall defining the shaping chamber prevents adherence of the substrate. This “nonstick” feature may be enhanced if the wall surface has “non-stick” properties or a “non-stick” coating has been applied thereto. However, in processes in which the substrate is continuously fed through the shaping/cooking fixture, such “non-stick” properties may result in overly rapid passage of the substrate through the shaping chamber. Thus, in some embodiments, it may be desirable to provide a back pressure that opposes the flow of the substrate through the chamber to ensure that the substrate is in the chamber for a sufficient time to attain the desired cooked state.

Provision of such a back pressure may be implemented in many different manners, including air pressure, hydraulic pressure, and mechanical limitations which can restrict the flow of the substrate. In some embodiments, the back pressure may be removed after the leading portion of the substrate has been cooked. That is, expansion of the leading portion as a result of cooking will provide a resistance in the shaping chamber against the flow of the following portions of the substrate. In other embodiments, it may be desirable to maintain the back pressure, but at a reduced level, after the leading portion has been cooked. In another exemplary embodiment, the shaping chamber itself may be configured to create a back pressure. For example, at least a portion of the chamber may be tapered in which the fixture includes a shaping chamber having an inlet for receiving the flowable substrate and an outlet through which the cooked product is expelled.

In one exemplary embodiment, the substrate is passed in a continuous manner through the fixture, and the energy source applies the cooking energy in a continuous manner. In other embodiments, the process may be configured such that the substrate fills a chamber, and then remains at rest until it is cooked. In such an embodiment, the energy source may be configured to apply the cooking energy in a discontinuous manner. For example, the energy source may be activated only while the substrate is at rest in the chamber. In such embodiments, the flow of the substrate through the chamber can be controlled merely by introducing the substrate into the fixture in a discontinuous manner. Thus, in such embodiments, provision of a back pressure may not be needed to ensure that the substrate remains in the chamber for a sufficient period of time.

In one embodiment, the energy source is a vibrational energy source (e.g., an ultrasonic source) which is configured to communicate with the chamber to vibrate the shaped surface of the chamber walls such that sufficient energy is transferred to the flowable emulsion to alter its physical and/or chemical state in a desired manner. For purposes of this disclosure, a physical and/or chemical change of state will be referred to as “cooked.” For example, it may be desired to provide sufficient energy to “cook” the ingredients of the flowable emulsion such that they no longer are in a raw state. Alternatively, it may be desired to provide sufficient energy to cook the emulsion such that the surface of the emulsion that is in contact with the chamber wall becomes hardened. Still further, it may be desired to provide adequate energy to cook the emulsion such that it is sufficiently stiffened or formed and can retain its shape after exiting the shaping chamber. In some embodiments, a combination of state changes may be desired when cooking the emulsion. For example, it may be desired to provide sufficient energy such that the ingredients are removed from the raw state, and the exterior surface of the emulsion is made into a hard shell.

The energy source may also be a different type of energy source or may include a plurality of different types of energy sources. For example, the energy source may include both a thermal energy source and an ultrasonic energy source. Regardless of the type of energy source, a cooked, shaped product exits the chamber. Upon exiting the chamber, a cutting device, such as a rotary blade, cuts the cooked shaped product into a plurality of pieces or chunks. For example, in a process for making animal food, the chunks are sized for compatibility with the animal that will consume the food product.

Alternatively, the meat chunks or pieces can be provided ready-made for dispensing into the pouches, such as diced or cubed chunks of beef, chicken, lamb, veal or pork. Ready-made meat and vegetable pieces would most likely be found in a processing line for human edible food products. Thus, in this embodiment of the method and system, a meat preparation module 12a (not shown) would include the placement of a variety of ready-made meat pieces and/or vegetables and/or rice and pasta products into an appropriate hopper for each different product as would be known to one skilled in the art of food processing. Any additional processing of these products would take place in the hopper or a mixing apparatus.

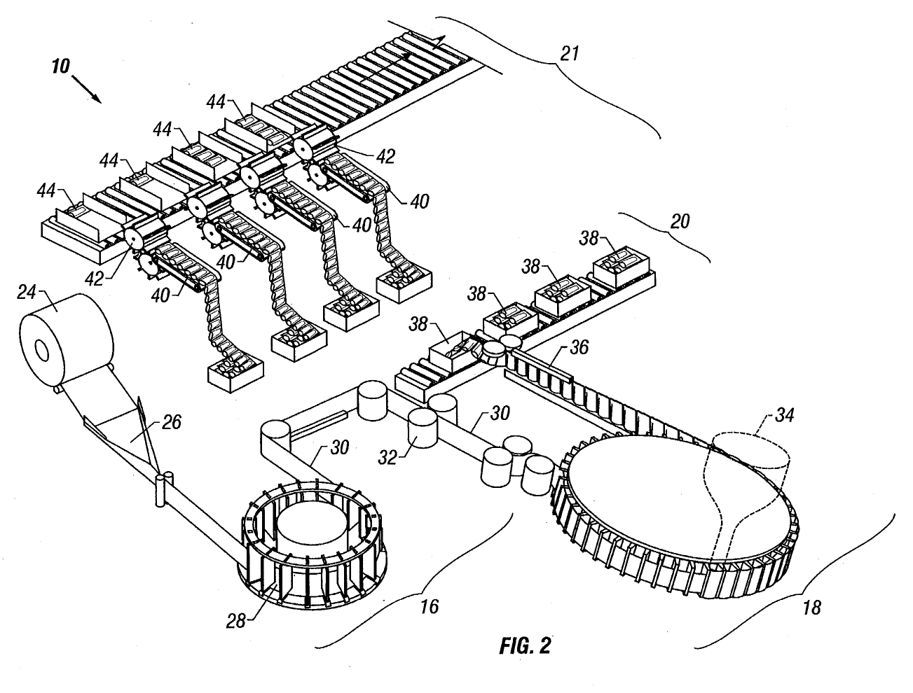

The pouch forming module 16 (FIGS. 2, 3) includes a separate, but integral, processing line configured for the formation of the pouches from a heat sealable, continuous plastic film as is known to one skilled in the art of forming pouches. In a typical pouch forming process known to one skilled in the art, rolls of film 24 are provided in which the film is fed through a plow 26 in order to fold the sheet of film 24. The vertical sides of the folded film are sealed 28 as well as the bottom of the pouch if necessary. This process creates a continuous strip of individual flexible pouches 30. Quick splicing techniques (not shown) can be used to change from one preprinted film to another film source (not shown) as different varieties of a pet food product or different kinds of pet food products are processed for the pouches. Alternatively, a portion of the continuous plastic film can be printed with text and graphics that would be appropriate for any variety of pet food or any different pet food product and a programmable high speed printing system 32 that imprints text on the front and/or back of each of the pouches in the continuous strip 30 can be used to print specific text for any single variety or single pet food product. In another embodiment, the processing line can utilize non-printed film in which the processing line would include the programmable high speed printing system 32 for imprinting the text and graphics on the front and back of each of the pouches in the continuous strip 30 as it runs through the printing system portion 32 of the line.

The pet food production line 10, at the completion of the meat forming and cooking module 14 or the completion of the meat preparation module 12a, converges with the pouch forming line at the filling and sealing module 18 (FIGS. 2, 3). At the filling station portion 34 of this module 18, an electronically controlled filling system, as is known to one skilled in the art, deposits a measured amount of the meat pieces and gravy or other food product into each of the pouches in the continuous strip of pouches 30. More than one filling station 34 can be utilized. Thereafter, the tops of the pouches are sealed 36.

At some pre-selected point in the processing, the sealed pouches 30 are processed through a sterilization module 15 (FIG. 3), which can utilize for example a continuous thermal or non-thermal (x-ray or electron beam) sterilization process. At this point in the process, the continuous strip of pouches 30 can either be left as a continuous strip of filled and sealed pouches or the strip can be cut into individual pouches 44, as is known to one skilled in the art of pouch making, and can be further transported in a cassette system as is known to one skilled in the art of pouch food processing.

In another embodiment of the subject invention, the meat preparation modules 12 and the meat forming and cutting module 14 can be run adjacent at least one of a typical high volume pet food production line (not shown) that is producing, for example, a generic meat chunk such as chicken. This high volume line can converge with the pet food production line 10 at the filling and sealing module 18 of the pouch forming line. At the filling station portion 34 of this module 18, an electronically controlled filling system, as is known to one skilled in the art, deposits a measured amount of the meat pieces and gravy or other pet food product from both the pet food production line 10 and the high volume pet food production line into each of the pouches in the continuous strip of pouches 30. In this embodiment any one continuous strip of pouches 30 could be filled with alternating varieties of a pet food product. Thereafter, the tops of the pouches are sealed 36.

In the accumulation module 20 (FIGS. 2, 3), the continuous strips of filled and sealed pouches 30 or individual pouches 44 are conveyed to a series of work boxes 38 in which the pouches 30, 44 are accumulated. The work boxes can be any dimension, stackable or not, and formed of any suitable material. The boxes can be made of a material that allows the boxes to be reuseable or of a material that provides for a limited life such as corrugated boxes. The continuous strips of pouches 30 can be layered, wound or spooled into the work boxes 38. Preferably, each work box 38 contains a different variety of a food product or different kinds of food product. The plurality of work boxes 38, preferably at least six, are thereafter each filled with a separate variety of a product or different kinds of product. After the plurality of work boxes 38 are filled, the filled boxes 38 can be moved to the packaging module 21 or the boxes 38 can be put aside until a larger number of boxes 38 containing separate varieties of a product or different kinds of product have been accumulated.

In the packaging module 21, the filled pouches can be in the form of the continuous strips of pouches 30 or have already been cut into individual pouches 44. If the continuous strips have not been cut, the strips 30 from each of the work boxes 38 can either be fed directly through separate cutting systems 42 in order to cut the continuous strips of pouches 30 into individual pouches 44 (FIG. 3) or conveyed by means of a conveyer belt 40 to the separate cutting systems 42 (FIG. 2). An indexing system 41, such as a continuous or intermittent motion type, collects the separated pouches 44 into multi-packs 46 which are then each packaged as an individual unit into a multi-pack 46 as is known to one skilled in the art of packaging. FIG. 3 illustrates a typical tray forming apparatus 43 that forms trays 45 for holding each of the separate multi-pack units 46 which are then individually shrunk-wrapped as is known to one skilled in the art of packaging. In another embodiment, a number of the separate multi-pack units 46, such as four or six, can be packaged into a box configured for dispensing one pouch at a time. Each multi-pack 46 can include pouches containing a variety of food products such as beef chunks, chicken chunks, veal chunks and meat combination chunks, in which each multi-pack would include, for example, four to six different varieties of the food product. Alternatively, each multi-pack 46 can include different food products such as a semi-moist chunk, a dry pet food, a pet snack, a pet treat or a human edible food product. If the product is a human edible food product, each multi-pack 46 can include a variety of different products such as meat and vegetable pieces, a rice and vegetable product, a rice and meat product, or a pasta and meat or vegetable product.

Alternatively, the continuous strip of pouches 30 could be left in strips of 15 to 30 attached pouches containing a variety of a pet food product. In the packaging module 21, each of the strips would be fan folded into a disposable box configured for dispensing the pouches one at a time.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for producing multi-packs of pouched food containing different varieties of a food product or different food products in a continuous production process, the method comprising the steps of:
a) providing a plurality of meat preparation modules, each module containing a different variety of a food product or different kinds of food products;
b) processing a meat mixture from at least one selected meat preparation module through a meat forming module;
c) providing a plurality of flexible pouches;
d) filling and sealing the plurality of flexible pouches with the selected meat mixture;
e) accumulating the plurality of filled flexible pouches in a work box;
f) repeating steps b) through e) in order to accumulate a plurality of work boxes containing different varieties of a food product or different food products; and
g) selecting pouches from the plurality of work boxes in order to form multi-packs of pouches wherein each multi-pack includes a variety of a food product or different food product.

2. The method of claim 1, further including the step of sterilizing the filled and sealed flexible pouches.

3. The method of claim 2, wherein the sterilization process is selected from a group consisting of thermal sterilization, x-ray sterilization and electron beam sterilization.

4. The method of claim 3, wherein the sterilization process is continuous or batch processing.

5. The method of claim 1, wherein the food products are selected from the group consisting of dry pet food, moist pet food, semi-moist pet food, pet snacks, pet treats, and human edible food.

6. The method of claim 1, wherein at least one of the meat preparation modules includes the steps of:
a) grinding a meat mixture to a relatively fine grind;
b) feeding the meat mixture into an emulsion blender where other ingredients are added; and
c) transferring the meat emulsion to the meat forming module.

7. The method of claim 1, wherein at least one of the plurality of meat preparation modules includes a meat component selected from a group consisting of beef, chicken, veal, lamb and a combination thereof.

8. The method of claim 1, wherein the meat forming module includes the steps of:
a) transporting a meat emulsion through an extruder;
b) depositing a shaped meat emulsion component onto a moving cooking belt;
c) transporting the shaped meat component through a cooking process;
d) cutting the shaped meat component into desired dimensions; and
e) transporting the cut meat components to a pouching filling station.

9. The method of claim 8, further including the step of transporting the cut meat components through a drying process.

10. The method of claim 1, wherein the meat forming module includes the steps of:
a) providing a shaping chamber extending between a first open end and a second open end
b) feeding a flowable meat mixture through the shaping chamber such that the chamber imparts a shape to the meat mixture;
c) applying a thermal energy source to the chamber sufficient to cook the meat mixture;
d) removing the shaped and cooked meat mixture from the chamber through the second open end; and
e) cutting the meat mixture into chunks after it has exited the second end of the chamber.

11. The method of claim 1, wherein the meat forming module includes the steps of:
a) feeding a flowable meat mixture through a chamber such that the chamber imparts a shape to the meat mixture;
b) applying a vibrational energy source to the chamber such that sufficient energy is transferred to the meat mixture to alter the physical and/or chemical state of the meat mixture;
c) cutting the meat mixture into chunks after it has exited the chamber.

12. The method of claim 1, wherein the plurality of flexible pouches is formed from a heat sealable, continuous plastic film.

13. The method of claim 1, wherein the filling and sealing of the plurality of flexible pouches further includes the step of filling the pouches with the meat mixture from a selected meat forming module and from a high volume pet food production line producing a generic meat mixture.

14. The method of claim 1, wherein the step of accumulating the filled pouches further includes the steps of:
a) conveying the filled pouches to a plurality of work boxes wherein each of the work boxes accumulates a different variety of a pet food product or different pet food products;
b) filling each of the plurality of work boxes with the filled pouches; and
c) accumulating a plurality of filled work boxes.

15. The method of claim 1, wherein the plurality of pouches is in the form of a continuous strip or individual pouches.

16. The method of claim 14, further including the step of transporting the pouches from each of the work boxes to a cutting apparatus in order to separate a continuous strip of pouches into individual pouches.

17. The method of claim 16, further including the steps of:
a) processing the individual pouches through an indexing apparatus in order to separate the pouches into individual multi-packs of pouches; and
b) packaging the individual multi-packs of pouches into individual boxes configured to dispense the pouches one at a time.

18. The method of claim 1 or 16, further including the steps of:
a) processing the pouches from the plurality of work boxes through an indexing apparatus in order to separate the pouches into individual multi-packs of pouches; and
b) packaging the multi-packs of pouches into individual units.

19. The method of claim 1, further including the steps of:
a) transporting the pouches from each of the work boxes to a cuffing apparatus in order to separate a continuous strip of pouches into individual strips of pouches, each strip including a plurality of pouches;
b) packaging the strips of pouches into individual boxes configured to dispense the pouches one at a time.

20. The method of claim 1, wherein the different varieties of a food product in the multi-pack of pouches is selected from the group consisting of a beef based component, a chicken based component, a veal based component, a lamb based component and a combination thereof.

21. The method of claim 1, wherein the different kinds of food products in the multi-packs of pouches is selected from a group consisting of dry pet food, moist pet food, semi-moist pet food, pet snacks, pet treats, and human edible food.

22. The method of claim 1, wherein the method provides for quick changeovers in a continuous production process allowing for the production of multi-packs of pouched food containing different varieties of a food product or different food products.

23. The method of claim 1, wherein the filling and sealing step further includes the addition of a gravy product.

24. A system for producing multi-packs of pouched food containing multiple varieties of a food product or different foods in a continuous production process, the system comprising:
a plurality of meat preparation modules for the preparation of multiple varieties of a food product or different kinds of food products;
a meat forming module;
a pouch forming module
a filling and sealing module;
an accumulation module; and
a packaging module;
the system being configured to form multi-packs of pouches wherein each multi-pack includes a variety of a food product or different food products.

25. The system of claim 24, further including a sterilization module for the filled and sealed flexible pouches.

26. The system of claim 24, wherein the food products are selected from the group consisting of dry pet food, moist pet food, semi-moist pet food, pet snacks, pet treats, and human edible food.

27. The system of claim 24, wherein at least one of the meat preparation modules includes at least the processes of:
a) grinding a meat mixture to a relatively fine grind;
b) feeding the meat mixture into an emulsion blender where other ingredients are added; and
c) transferring the meat emulsion to the meat forming module.

28. The system of claim 24, wherein at least one of the plurality of meat preparation modules includes a meat component selected from a group consisting of beef, chicken, veal, lamb and a combination thereof.

29. The system of claim 24, wherein the meat forming module includes at least the processes of:
a) transporting a meat emulsion through an extruder;
b) depositing a shaped meat emulsion component onto a moving cooking belt;
c) transporting the shaped meat component through a cooking process;
d) cutting the shaped meat component into desired dimensions; and
e) transporting the cut meat components to a pouch filling station.

30. The system of claim 29, the meat forming module further including the process of transporting the cut meat components through a drying process.

31. The method of claim 24, wherein the meat forming module includes the steps of:
a) providing a shaping chamber extending between a first open end and a second open end
b) feeding a flowable meat mixture through the shaping chamber such that the chamber imparts a shape to the meat mixture;
c) applying a thermal energy source to the chamber sufficient to cook the meat mixture;
d) removing the shaped and cooked meat mixture from the chamber through the second open end; and
e) cutting the meat mixture into chunks after it has exited the second end of the chamber.

32. The method of claim 24, wherein the meat forming module includes the steps of:
a) feeding a flowable meat mixture through a chamber such that the chamber imparts a shape to the meat mixture;
b) applying a vibrational energy source to the chamber such that sufficient energy is transferred to the meat mixture to alter the physical and/or chemical state of the meat mixture;
c) cutting the meat mixture into chunks after it has exited the chamber.

33. The system of claim 24, wherein the pouch forming module forms a continuous strip of flexible pouches formed from a heat sealable, continuous plastic film.

34. The system of claim 24, wherein the accumulation module includes at least the processes of:
a) conveying the filled pouches to a plurality of work boxes wherein each of the work boxes accumulates a different variety of a food product or different food products;
b) filling each of the plurality of work boxes with the filled pouches; and
c) accumulating a plurality of filled work boxes.

35. The system of claim 24, wherein the plurality of pouches is in the form of a continuous strip or individual pouches.

36. The system of claim 34, further including transporting the pouches from each of the work boxes to a cutting apparatus in order to separate the continuous strip of pouches into individual pouches.

37. The system of claim 24 or 36, wherein the packaging module further includes the process of:
a) processing the pouches from the plurality of work boxes through an indexing apparatus in order to separate the pouches into individual multi-packs of pouches; and
b) packaging the multi-packs of pouches into individual units.

38. The system of claim 24, wherein the different varieties of a food product in the multi-pack of pouches is selected from the group consisting of a beef based component, a chicken based component, a veal based component, a lamb based component and a combination thereof.

39. The system of claim 24, wherein the different kinds of food products in the multi-packs of pouches is selected from a group consisting of dry pet food, moist pet food, semi-moist pet food, pet snacks, pet treats, and human edible food.

40. The system of claim 24, wherein the method provides for quick changeovers in a continuous production process allowing for the production of multi-packs of pouched food products containing different varieties of a food product or different food products.

41. The system of claim 24, wherein the filling and sealing module further includes the addition of a gravy product.

42. A method for producing multi-packs of pouched food containing different varieties of a food product or different food products in a continuous production process, the method comprising the steps of:
a) providing a plurality of meat preparation modules, each module containing a different variety of a food product or different kinds of food products;
b) providing a plurality of flexible pouches;
c) filling and sealing the plurality of flexible pouches with a selected product from at least one of the meat preparation modules;
d) accumulating the plurality of filled flexible pouches in a work box;
e) repeating steps b) through d) in order to accumulate a plurality of work boxes containing different varieties of a food product or different food products; and
f) selecting pouches from the plurality of work boxes in order to form multi-packs of pouches wherein each multi-pack includes a variety of a food product or different food products.

43. The method of claim 42, further including the step of sterilizing the filled and sealed flexible pouches.

44. The method of claim 42, wherein the meat preparation modules include food products selected from the group consisting of meat pieces, vegetable pieces, a rice product, a pasta product and a combination thereof.

45. The method of claim 42, wherein the filling step further includes the addition of a sauce.
